(19) United States
(12) Patent Application Publication
(10) Pub. No.: US 2018/0174388 A1
(43) Pub. Date: Jun. 21, 2018

(54) MAGNETIC DATA READING DEVICE AND MAGNETIC DATA READING METHOD

(71) Applicant: Shandong New Beiyang Information Technology Co., Ltd., Shandong (CN)

(72) Inventors: Chunkai XU, Shandong (CN); Quanli WANG, Shandong (CN); Bingqing LIU, Shandong (CN); Shuxun DONG, Shangdong (CN); Lu SUN, Shangdong (CN)

(73) Assignee: Shandong New Beiyang Information Technology Co., L td, Shandong (CN)

(21) Appl. No.: 15/323,383

(22) PCT Filed: Jul. 2, 2015
(86) PCT No.: PCT/CN2015/083211

§ 371 Date: Dec. 30, 2016

(30) Foreign Application Priority Data
Jul. 15, 2014 (CN) 201410337152.0

(51) Int. Cl. G07D 7/04; G07D 7/20; G06K 7/08

(52) U.S. Cl. CPC G07D 7/04; G06K 7/087; G07D 7/20

(57) ABSTRACT

A magnetic data reading apparatus and magnetic data reading method are provided. The magnetic data reading apparatus includes a magnetic head apparatus (211) and a controller (20). The magnetic head apparatus (211) includes a magnetic core (10) and a magnet exciting coil (11) wound around the magnetic core (10). The controller is configured to control the magnet exciting coil (11) to be energized for a first preset time (T1) and read first magnetic data of a bill to be read when energizing time reaches the first preset time (T1), and is further configured to control the magnet exciting coil (11) to be de-energized for a second preset time (T2) and read second magnetic data of the bill to be read when de-energizing time reaches the second preset time (T2).

### RELATED APPLICATIONS

This application is a National Stage Entry of PCT International Application No. PCT/CN2015/083211, filed Jul. 2, 2015, which claims priority to CN Application No. 201410337152.0 filed Jul. 15, 2014, the contents of which are incorporated herein by reference in their entirety.

### TECHNICAL FIELD

The present disclosure relates to the technical field of magnetic detection, in particular to a magnetic data reading device and a magnetic data reading method.

### BACKGROUND

Magnetic substances are contained in all the valuable bills, such as paper currencies and cheques. Thus, it is a common means in the field of authenticity identification for bills to identify authenticity of the bills by detecting the magnetic substances contained in specific regions of the bills. A traditional method for identifying the authenticity of bills is: determining the authenticity of the bills by detecting whether there exist magnetic substances on the bills with a magnetic head apparatus. With such method, the detection and analysis on the magnetic substances are too simple, and counterfeit bills cannot be effectively distinguished, so that the accuracy of bill authenticity identification is not high.

In order to improve anti-counterfeiting characteristics of the bills, hard magnetic substances and soft magnetic substances are usually contained in the existing bills. For example, soft magnetic anti-counterfeiting features are added in the fifth edition of RMB based on hard magnetic anti-counterfeiting features of the fourth edition of RMB. Specifically, the hard magnetic substances and the soft magnetic substances are mixed at security thread, serial number, magnetic ink and the like of the bills and are distributed in a certain rule. Herein, the hard magnetic substances refer to materials capable of retaining magnetism for a long time after being magnetized, and after an external magnetic field being removed, directions of all magnetic domains can keep well consistent, and the hard magnetic substances have strong residual magnetism. The soft magnetic substances refer to materials that cannot retain original magnetism after being magnetized, and after the external magnetic field being removed, directions of all magnetic domains cannot keep consistent, and the soft magnetic substances have no apparent residual magnetism.

FIG. 1 is a structural schematic diagram illustrating a magnetic induction apparatus in the relevant technology. It can be seen from the figure that the magnetic induction apparatus includes a magnetic head 1 to which an external magnetic field is applied and a magnetic head 1′ to which no external magnetic field is applied. The magnetic heads of the magnetic induction apparatus are arranged in two rows and n columns, and Y direction as shown in the figure is a column direction. Magnetic substances to be induced move forward along the Y direction in the magnetic induction apparatus, and the two magnetic heads in the same column are the magnetic head 1 and the magnetic head 1′ respectively, which can be arranged in any order. When magnetic substances to be induced pass through the magnetic head 1, both of the soft magnetic substances and the hard magnetic substances can be induced by the magnetic head 1. However, when the magnetic substances to be induced pass through the magnetic head 1′, the soft magnetic substances have little residual magnetism because it is easy to be demagnetized, while the hard magnetic substances have greater residual magnetism, as a result, the magnetic head 1′ generates different induction signals with respect to the soft magnetic substances and the hard magnetic substances. Therefore, the two magnetic heads generate different induction signals no matter the magnetic substances to be induced pass through which magnetic head of the magnetic induction apparatus first. A bill detection system containing the magnetic induction apparatus analyzes and processes the induction signals generated by the two magnetic heads to obtain soft magnetic image and hard magnetic image of the bills, so as to realize the detection and authenticity identification of the bills.

However, the magnetic induction apparatus of the relevant technology needs to be provided with at least two magnetic heads, which not only increases structural complexity of the magnetic induction apparatus, but also increases manufacturing cost of the magnetic induction apparatus to a certain extent.

No effective solution has been proposed at present for the problem that the magnetic induction apparatus is high in manufacturing cost in the relevant technology.

### SUMMARY

The present disclosure is to provide a magnetic data reading apparatus and a magnetic data reading method to solve the above problems.

An embodiment of the present invention provides a magnetic data reading apparatus for reading magnetic data of a bill to be read, including a magnetic head apparatus and a controller, the magnetic head apparatus includes a magnetic core and a magnet exciting coil wound around the magnetic core; the controller is configured to control the magnet exciting coil to be energized for a first preset time, and read first magnetic data of the bill to be read when energizing time reaches the first preset time; the controller is further configured to control the magnet exciting coil to be de-energized for a second preset time, and read second magnetic data of the bill to be read when de-energizing time reaches the second preset time.

The magnetic data reading apparatus further includes a power supply and a signal processing circuit. The magnet exciting coil has a first terminal and a second terminal. The power supply is connected with the first terminal through a power supply control switch, the power supply control switch is configured to respond to a closing and an opening control signal transmitted from the controller. The signal processing circuit is connected with the second terminal and is configured to transmit the first magnetic data and the second magnetic data to the controller under the control of the controller.

The controller is configured to control the magnet exciting coil to be energized by controlling the power supply control switch to be closed, start a first timekeeping and determine whether energizing time of the magnet exciting coil reaches the first preset time according to the first timekeeping; the controller is configured to control the magnet exciting coil to be de-energized by controlling the power supply control switch to be opened, start a second timekeeping and determine whether the de-energizing time of the magnet exciting coil reaches the second preset time according to the second timekeeping.

The magnetic data reading apparatus further includes a conveyor, the conveyor includes a bill conveying passage. The magnetic head apparatus forms an induction region in the bill conveying passage, and the conveyor is configured to drive the bill to be read to move in the bill conveying passage under the control of the controller.

The magnetic data reading apparatus further includes a sensor, the sensor is arranged on the bill conveying passage, and is configured to detect a positional relationship between the bill to be read and the induction region.

The magnetic data reading apparatus further includes a storage device for storing the first magnetic data and the second magnetic data read by the controller.

The controller is further configured to determine authenticity of the bill to be read according to the first magnetic data and the second magnetic data after the first magnetic data and the second magnetic data being read.

An embodiment of the present invention further provides a magnetic data reading method for a magnetic data reading apparatus, the magnetic data reading apparatus being configured to read magnetic data of a bill to be read, and including a magnetic head apparatus; the magnetic head apparatus includes a magnetic core and a magnet exciting coil wound around the magnetic core; the magnetic data reading method includes the following steps: controlling the magnet exciting coil to be energized for a first preset time and reading first magnetic data of the bill to be read when energizing time reaches the first preset time; and controlling the magnet exciting coil to be de-energized for a second preset time and reading second magnetic data of the bill to be read when de-energizing time reaches the second preset time.

The step of reading first magnetic data and reading second magnetic data includes: detecting a positional relationship between the bill to be read and an induction region formed by the magnetic head apparatus; starting to read the first magnetic data and the second magnetic data when it is detected that a front edge of the bill to be read arrives at the induction region; and stopping reading the first magnetic data and the second magnetic data when it is detected that a rear edge of the bill to be read leaves the induction region.

The magnetic data reading method further includes: reading the first magnetic data and the second magnetic data of the bill to be read every time that the bill to be read moves for one unit distance.

The magnetic data reading method further includes the following steps: storing the first magnetic data after reading the first magnetic data of the bill to be read; and storing the second magnetic data after reading the second magnetic data of the bill to be read.

The magnet exciting coil is connected with a power supply through a power supply control switch; the magnet exciting coil is controlled to be energized by controlling the power supply control switch to be closed, and a first timekeeping is started, whether the energizing time of the magnet exciting coil reaches the first preset time is determined according to the first timekeeping; and the magnet exciting coil is controlled to be de-energized by controlling the power supply control switch to be opened, and a second timekeeping is started, whether the de-energizing time of the magnet exciting coil reaches the second preset time is determined according to the second timekeeping.

The magnetic data reading method further includes: determining authenticity of the bill to be read according to the first magnetic data and the second magnetic data after the first magnetic data and the second magnetic data being read.

According to the magnetic data reading apparatus and the magnetic data reading method provided by the embodiments of the present invention, the magnet exciting coil is controlled to be energized for the first preset time, and the first magnetic data of the bill to be read is read when energizing time reaches the first preset time, and the first magnetic data includes hard magnetic data and soft magnetic data; the magnet exciting coil is controlled to be de-energized for the second preset time, and the second magnetic data of the bill to be read is read when de-energizing time reaches the second preset time, and the second magnetic data is hard magnetic data. It can be seen that, the magnetic data reading apparatus provided by the embodiments of the present invention is only provided with one magnetic head apparatus, and can read the first magnetic data and the second magnetic data of the bill through controlling the energizing and de-energizing of the magnet exciting coil in the magnetic head apparatus in a time-sharing manner. Compared with the existing art, the magnetic data reading apparatus and the magnetic data reading method provided by the present disclosure only need to be provided with one magnetic head, thereby reducing cost of the magnetic data reading apparatus and solving a problem of high manufacturing cost of a magnetic induction apparatus in the existing art.

### BRIEF DESCRIPTION OF DRAWINGS

Drawings constituting a part of the present application are used for providing further understanding of the present disclosure. Exemplary embodiments of the present invention and the description thereof are used for explaining the present disclosure, rather than limiting the present disclosure. In the drawings:

FIG. 1 is a structural schematic diagram illustrating a magnetic induction apparatus in the relevant technology;

FIG. 2 is a structural schematic diagram illustrating a magnetic head apparatus according to embodiments of the present invention;

FIG. 3 is a schematic diagram illustrating a magnetic head apparatus and a control circuit thereof according to embodiments of the present invention;

FIG. 4 is a schematic diagram illustrating a module composition of a magnetic data reading apparatus according to embodiments of the present invention;

FIG. 5 is a structural schematic diagram illustrating a magnetic data reading apparatus according to embodiments of the present invention;

FIG. 6 is a flow chart illustrating a magnetic data reading method according to embodiments of the present invention; and

FIG. 7 is another flow chart illustrating a magnetic data reading method according to embodiments of the present invention.

### DETAILED DESCRIPTION

It should be noted that, embodiments in the present application as well as features in the embodiments can be combined in case of no conflict. The present disclosure is described below in details with reference to the drawings and in combination with embodiments.

An embodiment of the present invention provides a magnetic data reading apparatus for reading magnetic data of a bill to be read, including a magnetic head apparatus and a controller, the magnetic head apparatus includes a magnetic core and a magnet exciting coil wound around the magnetic core; the controller is configured to control the magnet exciting coil to be energized for a first preset time, and read first magnetic data of the bill to be read when energizing time reaches the first preset time; and the controller is further configured to control the magnet exciting coil to be de-energized for a second preset time, and read second magnetic data of the bill to be read when de-energizing time reaches the second preset time.

The magnetic data reading apparatus is only provided with one magnetic head apparatus and can read the first magnetic data and the second magnetic data of the bill through controlling the magnetic head apparatus in a time-sharing manner, thereby reducing cost of the magnetic data reading apparatus.

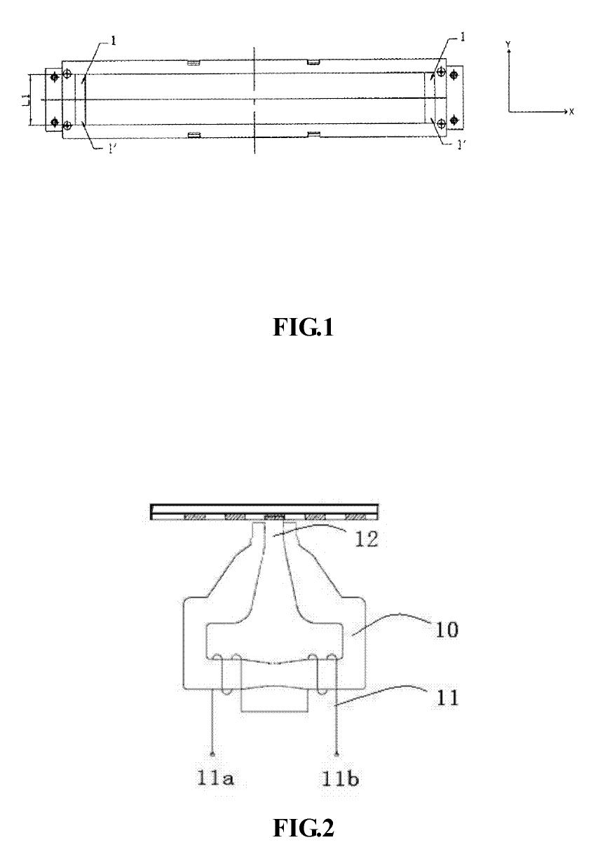

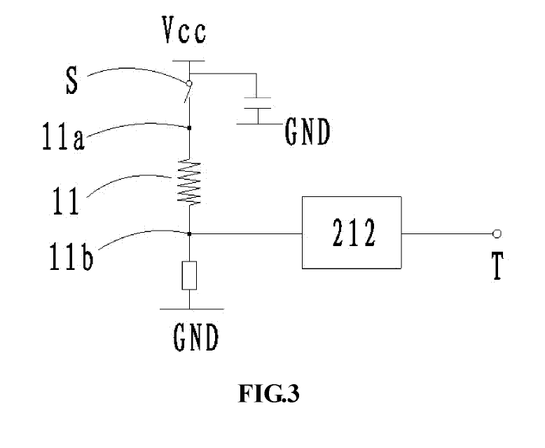

FIG. 2 is a structural schematic diagram illustrating the magnetic head apparatus of the magnetic data reading apparatus according to the embodiment of the present invention. FIG. 3 is a schematic diagram illustrating the magnetic head apparatus and a control circuit thereof according to the embodiment of the present invention. A structure and operating principles of the magnetic head apparatus are specifically described below in combination with FIG. 2 and FIG. 3.

As shown in FIG. 2, the magnetic head apparatus includes a magnetic core 10 and a magnet exciting coil 11 wound on the magnetic core 10, and the magnet exciting coil 11 includes a first terminal 11a and a second terminal 11b. As shown in FIG. 3, the first terminal 11a is connected with a power supply Vcc through a power supply control switch S, and the second terminal 11b is connected with a signal processing circuit 212.

When the power supply control switch S is closed, the power supply Vcc is connected to the magnet exciting coil 11, and there is current flowing through the magnet exciting coil 11, thereby generating a magnetic field at an opening 12 formed by the magnetic core 10. When the power supply control switch S is opened, there is no current flowing through the magnet exciting coil 11, thereby the magnetic field at the opening 12 formed by the magnetic core 10 disappears.

An electric signal outputted from the second terminal 11b is received and processed by the signal processing circuit 212. The processing performed by the signal processing circuit 212 on the electrical signal outputted from the second terminal 11b includes amplification processing, filtering processing and analog-digital (AD) conversion processing. After the electrical signal outputted by the second terminal 11b being processed, the signal processing circuit 212 outputs a digital signal obtained by AD conversion at an output terminal T of the signal processing circuit.

When magnetic substances are located at the opening 12 of the magnetic head apparatus, if the power control switch S is in a closed state, a current flows through the magnet exciting coil 11, thereby generating a magnetic field at the opening 12. The magnetic substances are magnetized at this moment and cause changes in inductance of the magnet exciting coil 11, and a first signal associated with the magnetic substances is outputted from the second terminal 11b. Since both the hard magnetic substance and the soft magnetic substance can be magnetized by the magnetic field at the opening 12, the generation of the first signal is a result of superposition of inductance change caused by the hard magnetic substance and inductance change caused by the soft magnetic substance. If the power control switch S is in an opened state, no current flows through the magnet exciting coil 11. As a result, no magnetic field is generated at the opening 12. At this moment, the magnetic substances cause changes in inductance of the magnet exciting coil 11 and a second signal associated with the magnetic substances is outputted from the second terminal 11b. Since the soft magnetic substance is easy to be demagnetized and has less residual magnetism, while the hard magnetic substance has greater residual magnetism, the generation of the second signal is mainly a result of the inductance change caused by the hard magnetic substance.

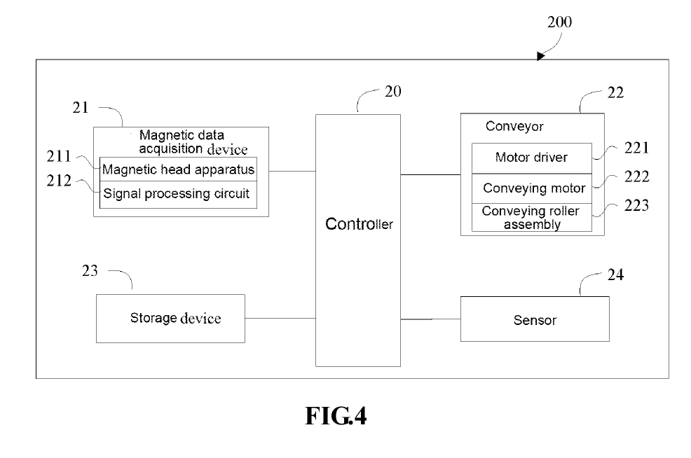

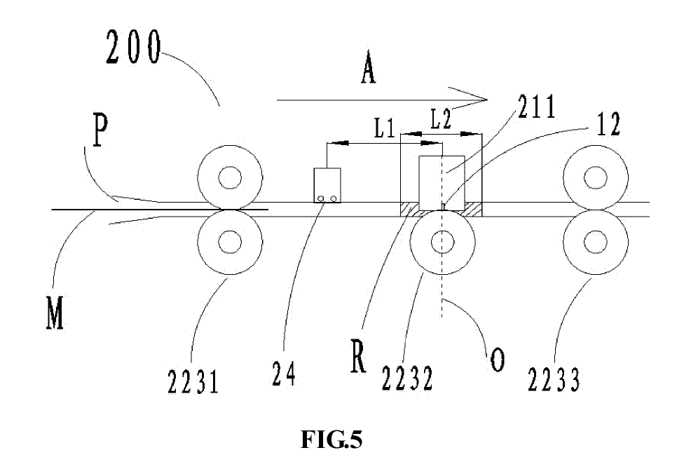

The embodiment of the present invention provides a specific implementation structure of the magnetic data reading apparatus based on the above magnetic data reading principle. As shown in FIG. 4, the magnetic data reading apparatus of the present embodiment primarily includes a controller 20, a magnetic data acquisition device 21 and a conveyor 22.

The magnetic data acquisition device 21 includes a magnetic head apparatus 211 and the signal processing circuit 212. The conveyor 22 includes a bill conveying passage. The magnetic head apparatus 211 forms an induction region in the bill conveying passage. The controller 20 is configured to control the conveyor 22 to drive the bill to be read to move in the bill conveying passage. For example, the conveyor 22 is controlled to drive the bill to be read to move to the induction region formed by the magnetic head apparatus 211. The controller 20 is further configured to control the magnet exciting coil of the magnetic head apparatus 211 to be energized for a first preset time T1, and read first magnetic data of the bill to be read outputted by the signal processing circuit 212 when energizing time reaches the first preset time T1. The controller 20 is further configured to control the magnet exciting coil to be de-energized for a second preset time T2, and read second magnetic data of the bill to be read outputted by the signal processing circuit 212 when de-energizing time reaches the second preset time T2.

After the first magnetic data and the second magnetic data being acquired, the controller 20 can process the first magnetic data and the second magnetic data as required. For example, the first magnetic data and the second magnetic data may be used for identifying authenticity of the bill and the like.

In the above apparatus, the magnetic data on the bill to be read is acquired by the magnetic data acquisition device 21. As mentioned above, the magnetic data acquisition device 21 includes the magnetic head apparatus 211 and the signal processing circuit 212. The magnetic head apparatus 211 is the magnetic head apparatus as shown in FIG. 2 and FIG. 3. The power supply VCC is connected with the first terminal 11a of the magnet exciting coil 11 through the power supply control switch S. The power supply control switch S responds to a closing and an opening control signal transmitted from the controller 20. Specifically, when a closing control signal is output by the controller 20, the power supply control switch S is closed and a current flows through the magnet exciting coil 11 of the magnetic head apparatus 211, thereby generating a magnetic field at the opening 12 formed by the magnetic core 10. When an opening control signal is output by the controller 20, the power supply control switch S is opened and no current flows through the magnet exciting coil 11, thus no magnetic field is generated at the opening 12 formed by the magnetic core 10. The signal processing circuit 212 is connected with the second terminal 11b of the magnetic head apparatus 211 (as shown in FIG. 3), and has the output terminal T electrically connected with the controller 20. The signal processing circuit 212 receives the signal outputted from the second terminal 11b, performs amplification processing, filtering processing and AD conversion processing on the signal, and outputs digital magnetic data generated after AD conversion to the controller 20.

The conveyor 22 is configured to drive the bill to move in the bill conveying passage of the magnetic data reading apparatus 200. The conveyor 22 includes a motor driver 221, a conveying motor 222 and a conveying roller assembly 223. The motor driver 221 is configured to output current required for rotation of an output shaft of the conveying motor 222 according to a control command outputted from the controller 20. The output shaft of the conveying motor 222 is in transmission connection with the conveying roller assembly 223. Therefore, the conveying roller assembly 223 rotates with the output shaft of the conveying motor 222 when the output shaft of the conveying motor 222 rotates, thereby driving the bill to move in the bill conveying passage.

As shown in FIG. 4, the magnetic data reading apparatus according to the embodiment of the present invention further includes a storage device 23. The storage device 23 is configured to store the first magnetic data and the second magnetic data read by the controller 20, and further configured to store a control program of the magnetic data reading apparatus 200 as well as data and variables generated during running of the control program. For example, the storage device 23 is configured to store the first preset time T1, the second preset time T2 and the like, where the first preset time T1 is a time preset for controlling the closing of the power supply control switch S and is configured to set closing time of the power supply control switch S of the magnetic head apparatus 211, and the second preset time T2 is a time preset for controlling the opening of the power supply control switch S and is configured to set opening time of the power supply control switch S of the magnetic head apparatus 211.

As shown in FIG. 4, the magnetic data reading apparatus further includes a sensor 24 which is arranged in the bill conveying passage and is configured to detect a positional relationship between the bill to be read and the induction region.

The sensor 24 may be a photoelectric reflection sensor or a photoelectric transmission sensor, including a light emitter and a receiver (not marked in the figure). The receiver receives light emitted from the light emitter and converts the light into an electrical signal. A first detection signal is output by the receiver 24 when the sensor is in a covered state, and a second detection signal is output by the receiver 24 when the sensor is in a non-covered state. The change of state of the sensor 24 can be used for indicating that the bill arrives at or leaves a detection position of the sensor 24. When the sensor 24 is changed from the non-covered state to the covered state, it indicates that the bill arrives at the detection position of the sensor 24; and when the sensor 24 is changed from the covered state to the non-covered state, it indicates that the bill leaves the detection position of the sensor 24.

FIG. 5 is a structural schematic diagram illustrating the magnetic data reading apparatus according to the embodiment of the present invention. As shown in the figure, a bill M is fed from an inlet P into the bill conveying passage of the magnetic data reading apparatus 200, where a direction indicated by an arrow A is a conveying direction of the bill M.

The sensor 24 is located at an upstream of the magnetic head apparatus 211 in the conveying direction of the bill M, and a distance between the detection position of the sensor 24 and a center line O of the magnetic head apparatus 211 is L1.

The conveying roller assembly 223 includes a conveying roller 2231, a conveying roller 2232, and a conveying roller 2233 successively arranged in the bill conveying passage along the conveying direction. The magnetic head apparatus 211 is arranged opposite to the conveying roller 2232. The opening 12 formed by the magnetic core 10 of the magnetic head apparatus 211 is located in the bill conveying passage in a manner of facing the conveying roller 2232. The conveying roller 2231 and the conveying roller 2233 include oppositely arranged driving roller and driven roller. The driving roller of the conveying roller 2231, the driving roller of the conveying roller 2233 and the conveying roller 2232 are in transmission connection with the conveying motor 222. The driving roller of the conveying roller 2231, the driving roller of the conveying roller 2233 and the conveying roller 2232 rotate with the output shaft of the conveying motor 222 when the output shaft of the conveying motor 222 rotates, thereby driving the bill M to move in the bill conveying passage.

During bill processing, the bill M enters from the inlet P and moves in the bill conveying passage. As the bill M moves in the bill conveying passage, a front edge of the bill M in the conveying direction (hereinafter referred to as the front edge of the bill) enters the induction region R of the magnetic head apparatus 211 firstly. As shown in FIG. 5, the induction region R of the magnetic head apparatus 211 refers to a section of fixed region shown by a shaded part in the bill conveying passage.

When the magnetic substance on the bill M is located in the induction region R of the magnetic head apparatus 211, the magnetic head apparatus 211 can read the bill M's magnetic data associated with the magnetic substance. The length of the induction region R of the magnetic head apparatus 211 in the bill conveying direction is L2. As can be known from the symmetry of the magnetic field that the induction region R of the magnetic head apparatus 211 is axially symmetrical with the center line O of the magnetic head apparatus 211. As the bill M moves in the bill conveying passage, the magnetic head apparatus 211 cannot read the magnetic data on the bill M after a rear edge of the bill M in the conveying direction (hereinafter referred to as the rear edge of the bill) leaves the induction region R of the magnetic head device 211.

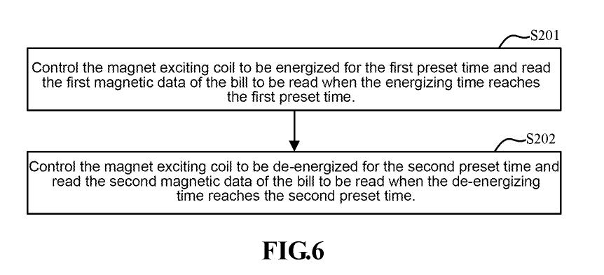

An embodiment of the present invention further provides a magnetic data reading method for a magnetic data reading apparatus, where the magnetic data reading apparatus is configured to read magnetic data of a bill to be read, and includes a magnetic head apparatus including a magnetic core and a magnet exciting coil wound around the magnetic core. As shown in FIG. 6, the magnetic data reading method of the embodiment mainly includes the following processing steps.

In step S201, the magnet exciting coil is controlled to be energized for the first preset time, and the first magnetic data of the bill to be read is read when energizing time reaches the first preset time.

The magnet exciting coil is controlled to be energized, for example, by controlling the power supply control switch to be closed, and a first timekeeping is started; and whether energizing time of the magnet exciting coil reaches the first preset time is determined according to the first timekeeping. The first magnetic data of the bill to be read is read when the energizing time of the magnet exciting coil reaches the first preset time.

In step S202, the magnet exciting coil is controlled to be de-energized for the second preset time, and the second magnetic data of the bill to be read is read when de-energizing time reaches the second preset time.

The magnet exciting coil is controlled to be de-energized, for example, by controlling the power supply control switch to be opened, and a second timekeeping is started; and whether de-energizing time of the magnet exciting coil reaches the second preset time is determined according to the second timekeeping. The second magnetic data of the bill to be read is read when the de-energizing time of the magnet exciting coil reaches the second preset time.

In the magnetic data reading method provided by the embodiment of the present invention, through controlling the energizing and de-energizing of the magnetic head apparatus in a manner of time-sharing, the first magnetic data and the second magnetic data of the bill are read. Thus, the method can be implemented by only one magnetic head apparatus, so that cost of the magnetic data reading apparatus is reduced.

In the above magnetic data reading method, validity of the first magnetic data and the second magnetic data acquired by the magnetic data reading apparatus may be relatively low when the bill to be read moves in the bill conveying passage and has not moved to a set induction region. To improve the validity of the acquired magnetic data and increase data processing efficiency, the first magnetic data and the second magnetic data are read when a part or all of the bill to be read is controlled to move to the set induction region.

The method is specifically implemented as follows: detecting a positional relationship between the bill to be read and the induction region formed by the magnetic head apparatus; starting to read the first magnetic data and the second magnetic data when it is detected that a front edge of the bill to be read arrives at the induction region; and stopping reading the first magnetic data and the second magnetic data when it is detected that a rear edge of the bill to be read leaves the induction region. The process of reading the first magnetic data and the second magnetic data includes: controlling the magnet exciting coil to be energized for the first preset time, and reading the first magnetic data of the bill to be read when energizing time reaches the first preset time; and controlling the magnet exciting coil to be de-energized for the second preset time, and reading the second magnetic data of the bill to be read when de-energizing time reaches the second preset time. Thus, the first magnetic data and the second magnetic data are read when a part or all of the bill to be read is located in the set induction region, thereby improving the validity of the acquired magnetic data.

The method for reading the first magnetic data and the second magnetic data provided by the embodiment of the present invention is described in details below in combination with the structure of the magnetic data reading apparatus.

A specific method for reading the first magnetic data in the embodiment of the present invention can be implemented as follows. A first control signal is transmitted by the controller to close the power supply control switch S, and the first timekeeping is started. When the power control switch S is closed, the power supply Vcc is connected with the magnet exciting coil, and a current flows through the magnet exciting coil, thereby generating a magnetic field at an opening formed by the magnetic core of the magnetic head apparatus. Since the opening formed by the magnetic core of the magnetic head apparatus is located at the bill conveying passage, the magnetic substance in the bill is magnetized when the bill is located at the induction region. When the first timekeeping reaches the first preset time T1, the controller reads digital magnetic data outputted from the magnetic data acquisition device and stores the digital magnetic data in the storage device, that is, the first magnetic data of the bill is read and stored in the storage device. Since the magnetic substance of the bill located at the induction region of the magnetic head apparatus is magnetized, the first magnetic data is generated due to a result of superposition of current changes in the magnet exciting coil caused by the hard magnetic substance and the soft magnetic substance located at the induction region of the magnetic head apparatus, that is, the first magnetic data includes hard magnetic data and soft magnetic data.

A specific method for reading the second magnetic data can be implemented as follows: a second control signal is transmitted by the controller to open the power supply control switch S, and the second timekeeping is started. When the power control switch S is opened, the power supply Vcc is disconnected with the magnet exciting coil, and no current flows through the magnet exciting coil, thus the magnetic field at the opening formed by the magnetic core of the magnetic head apparatus disappears. The soft magnetic substance on the bill is demagnetized after the magnetic field disappears. When the second timekeeping reaches the second preset time T2, the controller reads the digital magnetic data outputted from the magnetic data acquisition device and stores the digital magnetic data in the storage device, that is, the second magnetic data of the bill is read and stored in the storage device. After being demagnetized, the soft magnetic substance of the bill has little residual magnetism, while the hard magnetic substance has greater residual magnetism. Therefore, the second magnetic data is generated mainly due to a result of the current change in the magnet exciting coil caused by the hard magnetic substance located at the induction region of the magnetic head apparatus, that is, the second magnetic data is hard magnetic data.

The first magnetic data and the second magnetic data can be processed as required after being acquired. For example, the first magnetic data and the second magnetic data can be used for identifying authenticity of the bill.

It should be noted that the execution order of steps S201 and S202 in the present embodiment may be arbitrary. That is, step S201 may be executed firstly, and then step S202 is executed, or step S202 may be executed firstly, and then step S201 is executed.

Further, in the case that the bill to be read moves in the bill conveying passage and a part or all of the bill is located at the induction region, the first magnetic data and the second magnetic data of the bill to be read can be read when the bill to be read moves for one unit distance.

According to the magnetic data reading method provided by the embodiment of the present invention, the energizing and de-energizing of the magnet exciting coil of the magnetic head device in the magnetic data reading apparatus are controlled in a manner of time sharing, and the magnetic data of the bill is read when the magnet exciting coil is energized and de-energized, thereby realizing the separation of the hard magnetic data of the bill. The magnetic data reading apparatus may obtain the soft magnetic data of the bill by analyzing and processing the first magnetic data and the second magnetic data. Therefore, the hard magnetic data and the soft magnetic data can be used for identifying the authenticity of the bill. Compared with the existing art, only one magnetic head is required in the present solution, thereby solving a problem of high manufacturing cost of a magnetic induction apparatus in the existing art.

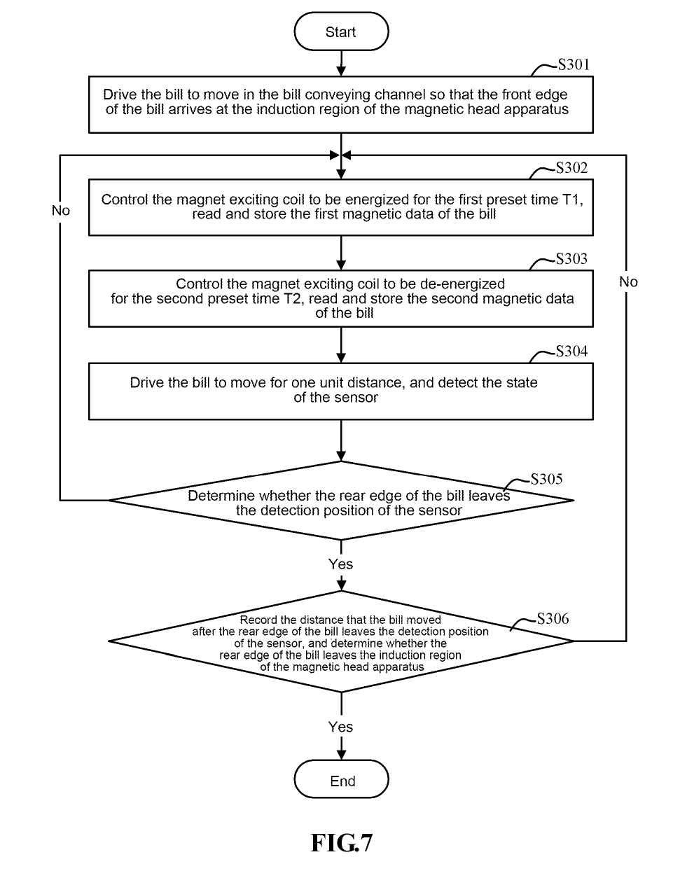

Embodiments of the present invention further provide another embodiment of the magnetic data reading method. As shown in FIG. 7, the method includes the following steps.

In step S301, the bill is driven to move in the bill conveying passage so that the front edge of the bill arrives at the induction region of the magnetic head apparatus.

The controller controls the conveyor to drive the bill to move in the bill conveying passage and detects the state of the sensor during the movement of the bill. It is determined that the front edge of the bill arrives at a detection position of the sensor when the sensor is detected to be changed from a non-covered state to a covered state. The conveyor is controlled to continue to drive the bill to move and a movement distance of the bill is started to be recorded at this moment. The controller determines that the front edge of the bill arrives at the induction region of the magnetic head apparatus when the movement distance of the bill reaches a first preset value. It can be known from FIG. 5 that when the front edge of the bill arrives at the detection position of the sensor, the bill continues to move a distance (L1−L2/2), then the front edge of the bill arrives at the induction region of the magnetic head apparatus. That is, the first preset value may set be (L1−L2/2). When the movement distance of the bill is greater than the first preset value, it is determined that the front edge of the bill enters the induction region of the magnetic head apparatus, where L1 is the distance from the detection position of the sensor to the center line of the magnetic head apparatus, and L2 is the length of the induction region of the magnetic head apparatus along the bill conveying direction.

The controller records the movement distance of the bill in the following manner: in the case that a conveying motor of the conveyor is a stepping motor, the controller records the steps of the stepping motor, and the movement distance of the bill is calculated according to the steps of the stepping motor and a distance that the bill moved in the bill conveying passage per step; in the case that the conveying motor of the conveyor is a DC (Direct Current) motor, the controller records a rotation angle of the DC motor, and the movement distance of the bill is calculated according to the rotation angle of the DC motor and a distance that the bill moved in the bill conveying passage when the DC motor is rotated by a minimum angle.

In Step S302, the magnet exciting coil is controlled to be energized for the first preset time T1, and the first magnetic data of the bill is read and stored.

The specific execution manner of the step is the same as that of step S201.

In Step S303, the magnet exciting coil is controlled to be de-energized for the second preset time T2, and the second magnetic data of the bill is read and stored.

The specific execution manner of the step is the same as that of step S202.

In Step S304, the bill is driven to move for one unit distance, and the state of the sensor is detected.

The controller controls the conveying motor to drive the bill to move for one unit distance. For example, in the case that the conveying motor is a stepping motor, the controller controls the stepping motor to move a step, while in the case that the conveying motor is a DC motor, the controller controls the DC motor to be rotated by a minimum angle. The controller detects the state of the sensor every time that the bill moves for one unit distance.

In Step S305, it is determined whether the rear edge of the bill leaves the detection position of the sensor.

The controller determines whether the rear edge of the bill leaves the detection position of the sensor according to the state of the sensor. When the sensor is detected to be changed from the covered state to the non-covered state, it is determined that the rear edge of the bill starts to leave the detection position of the sensor. Optionally, it is determined that the rear edge of the bill has left the detection position of the sensor if the sensor is detected to be in the non-covered state continuously when the bill moves for two unit distances. When it is determined by the controller that the rear edge of the bill starts to leave or has left the detection position of the sensor, that is when it is detected that the rear edge of the bill leaves the detection position of the sensor, step S306 is executed, or else, step S302 is executed.

In Step S306, a distance that the bill moved after the rear edge of the bill leaves the detection position of the sensor is recorded, and it is determined whether the rear edge of the bill leaves the induction region of the magnetic head apparatus.

When it is determined by the controller that the rear edge of the bill starts to leave the detection position of the sensor, the controller starts to record the distance that the bill moved, that is, the controller records the distance that the bill moved after the rear edge of the bill leaves the detection position of the sensor, and compares the distance of the bill with a second preset value to determine whether the rear edge of the bill leaves the induction region of the magnetic head apparatus. It can be known from FIG. 5 that when the rear edge of the bill starts to leave the detection position of the sensor, the bill continues to move for a distance of (L1+L2/2), then the rear edge of the bill leaves the induction region of the magnetic head apparatus, that is, the second preset value may be set as (L1+L2/2). It is determined that the rear edge of the bill has left the induction region of the magnetic head apparatus when the movement distance of the bill is greater than the second preset value, where L1 is the distance from the detection position of the sensor to the center line of the magnetic head apparatus, and L2 is the length of the induction region of the magnetic head apparatus along the bill conveying direction.

When it is determined by the controller that the rear edge of the bill leaves the induction region of the magnetic head apparatus, the flow ends, or else, step S302 is proceeded.

In the present embodiment, the first magnetic data and the second magnetic data of the bill located at the induction region of the magnetic head apparatus are respectively acquired every time the bill moves for one unit distance, so as to acquire the magnetic data of the whole bill when the whole bill passes through the induction region of the magnetic head apparatus.

The magnetic data reading method of the present invention is not limited to the above embodiments. For example, the present disclosure can acquire the magnetic data of the whole bill in an asynchronous manner, that is, the conveying of the bill and the reading of the magnetic data are two separate processes. The conveying motor drives the bill to move in the bill conveying passage. The reading of the magnetic data is started when it is detected that the front edge of the bill arrives at the induction region of the magnetic head apparatus, and the reading of the magnetic data is stopped when it is detected that the rear edge of the bill leaves the induction region of the magnetic head apparatus, where the magnetic data reading apparatus provided by embodiments of the present invention can use the method shown in FIG. 6 for reading the magnetic data of the bill (that is, the magnet exciting coil is controlled to be energized for the first preset time, and the first magnetic data of the bill to be read is read when the energizing time reaches the first preset time, and the magnet exciting coil is controlled to be de-energized for the second preset time, and the second magnetic data of the bill to be read is read when the de-energizing time reaches the second preset time).

The above descriptions are only embodiments of the present invention, rather than a limit to the present disclosure. For those skilled in the art, the present disclosure may be subjected to a variety of modifications and changes. Any modification, equivalent replacement, improvement and the like made within the spirit and the principle of the present disclosure shall be included in the protection scope of the present disclosure.

1. A magnetic data reading apparatus for reading magnetic data of a bill to be read, comprising a magnetic head apparatus and a controller, wherein
the magnetic head apparatus comprises a magnetic core and a magnet exciting coil wound around the magnetic core;
the controller is configured to control the magnet exciting coil to be energized for a first preset time, and read first magnetic data of the bill to be read when energizing time reaches the first preset time; and the controller is further configured to control the magnet exciting coil to be de-energized for a second preset time, and read second magnetic data of the bill to be read when de-energizing time reaches the second preset time.

2. The magnetic data reading apparatus according to claim 1, further comprising a power supply and a signal processing circuit, wherein
the magnet exciting coil has a first terminal and a second terminal;
the power supply is connected with the first terminal through a power supply control switch, wherein the power supply control switch is configured to respond to a closing and an opening control signal transmitted from the controller; and
the signal processing circuit is connected with the second terminal, and is configured to transmit the first magnetic data and the second magnetic data to the controller under the control of the controller.

3. The magnetic data reading apparatus according to claim 2, wherein the controller is configured to control the magnet exciting coil to be energized by controlling the power supply control switch to be closed, start a first timekeeping and determine whether the energizing time of the magnet exciting coil reaches the first preset time according to the first timekeeping; the controller is configured to control the magnet exciting coil to be de-energized by controlling the power supply control switch to be opened, start a second timekeeping and determine whether the de-energizing time of the magnet exciting coil reaches the second preset time according to the second timekeeping.

4. The magnetic data reading apparatus according to claim 1, further comprising a conveyor, wherein
the conveyor comprises a bill conveying passage, wherein an induction region is formed in the bill conveying passage by the magnetic head apparatus; and
the conveyor is configured to drive the bill to be read to move in the bill conveying passage under the control of the controller.

5. The magnetic data reading apparatus according to claim 4, further comprising a sensor, wherein the sensor is arranged on the bill conveying passage and is configured to detect a positional relationship between the bill to be read and the induction region.

6. The magnetic data reading apparatus according to claim 1, further comprising a storage device for storing the first magnetic data and the second magnetic data read by the controller.

7. The magnetic data reading apparatus according to claim 1, wherein the controller is further configured to identify authenticity of the bill to be read according to the first magnetic data and the second magnetic data after the first magnetic data and the second magnetic data being read.

8. A magnetic data reading method for a magnetic data reading apparatus, the magnetic data reading apparatus being configured to read magnetic data of a bill to be read and comprises a magnetic head apparatus, the magnetic head apparatus comprising a magnetic core and a magnet exciting coil wound around the magnetic core, the magnetic data reading method comprising the following steps:
controlling the magnet exciting coil to be energized for a first preset time, and reading first magnetic data of the bill to be read when energizing time reaches the first preset time; and
controlling the magnet exciting coil to be de-energized for a second preset time, and reading second magnetic data of the bill to be read when de-energizing time reaches the second preset time.

9. The method according to claim 8, wherein the step of reading first magnetic data and the step of reading second magnetic data comprise:
detecting a positional relationship between the bill to be read and an induction region formed by the magnetic head apparatus;
starting to read the first magnetic data and the second magnetic data when it is detected that a front edge of the bill to be read arrives at the induction region; and
stopping reading the first magnetic data and the second magnetic data when it is detected that a rear edge of the bill to be read leaves the induction region.

10. The method according to claim 8, further comprising: reading the first magnetic data and the second magnetic data of the bill to be read every time that the bill to be read moves for one unit distance.

11. The method according to claim 8, further comprising:
storing the first magnetic data of the bill to be read after the first magnetic data being read; and
storing the second magnetic data of the bill to be read after the second magnetic data being read.

12. The method according to claim 8, wherein the magnet exciting coil is connected with a power supply through a power supply control switch, wherein
controlling the magnet exciting coil to be energized by controlling the power supply control switch to be closed, starting a first timekeeping and determining whether the energizing time of the magnet exciting coil reaches the first preset time according to the first timekeeping; and
controlling the magnet exciting coil to be de-energized by controlling the power supply control switch to be opened, starting a second timekeeping and determining whether the de-energizing time of the magnet exciting coil reaches the second preset time according to the second timekeeping.

13. The method according to claim 8, wherein, after the first magnetic data and the second magnetic data being read, the magnetic data reading method further comprises:
determining authenticity of the bill to be read according to the first magnetic data and the second magnetic data.
